(19) United States
(12) Patent Application Publication
(10) Pub. No.: US 2026/0231150 A1
(43) Pub. Date: Aug. 6, 2026

(54) COMMUNICATION METHOD, ELECTRONIC DEVICE AND STORAGE MEDIUM

(71) Applicant: Beijing Xiaomi Mobile Software Co., Ltd., Beijing (CN)

(72) Inventor: Xiandong DONG, Beijing (CN)

(73) Assignee: Beijing Xiaomi Mobile Software Co., Ltd., Beijing (CN)

(21) Appl. No.: 19/153,161

(22) PCT Filed: Feb. 3, 2023
(86) PCT No.: PCT/CN2023/074455

§ 371 Date: Aug. 1, 2025

(51) Int. Cl. H04W 72/20; H04W 76/11

(52) U.S. Cl. CPC H04W 72/20; H04W 76/11

(57) ABSTRACT

A communication method is applied to a first access point device (AP) and includes: determining a first radio frame, wherein the first radio frame comprises first identification information, and the first identification information identifies whether the first AP supports the sharing of a wireless transmission resource with a second AP; and sending the first radio frame.

### CROSS-REFERENCE TO RELATED APPLICATIONS

This application is the National Stage of International Application No. PCT/CN2023/074455, filed on Feb. 3, 2023, which is incorporated by reference herein in its entirety for all purposes.

### TECHNICAL FIELD

Embodiments of the present disclosure relate to the field of mobile communication technology. Specifically, the embodiments of the present disclosure relate to a communication method, an electronic device, and a storage medium.

### BACKGROUND

In Ultra High Reliability (UHR), a method for coordinating resources between multiple APs is proposed to enhance the management of Overlapping Basic Service Sets (OBSS), which is to be further enhanced in UHR. Accordingly, it is to provide a specific method for coordinating resources between multiple APs to support UHR.

### SUMMARY

Embodiments of the present disclosure provide a communication method, an electronic device, and a storage medium to provide a specific manner for coordinating resources among multiple APs.

According to one aspect, an embodiment of the present disclosure provides a communication method, which is applied to a first access point device AP and includes:

determining a first radio frame; where the first radio frame includes first identification information, and the first identification information identifies whether the first AP supports sharing wireless transmission resource with a second AP; and sending the first radio frame.

According to another aspect, an embodiment of the present disclosure further provides a communication method, which is applied to a second access point device AP and includes:
receiving a first radio frame; where the first radio frame comprises first identification information, and the first identification information identifies whether a first AP supports sharing wireless transmission resource with the second AP.

According to another aspect, an embodiment of the present disclosure further provides an electronic device, where the electronic device is a first access point device AP and includes:
a determining module, configured to determine a first radio frame; where the first radio frame includes first identification information, and the first identification information identifies whether the first AP supports sharing wireless transmission resource with a second AP; and
a sending module, configured to send the first radio frame.

According to another aspect, an embodiment of the present disclosure further provides an electronic device, where the electronic device is a second access point device AP and includes:
a receiving module, configured to receive a first radio frame; where the first radio frame includes first identification information, and the first identification information identifies whether a first AP supports sharing wireless transmission resource with the second AP.

The embodiments of the present disclosure also provide an electronic device, including a memory, a processor, and a computer program stored in the memory and executable by the processor, where the processor, upon executing the program, is configured to implement one or more methods described in the embodiments of the present disclosure.

The embodiments of the present disclosure further provide a computer-readable storage medium, on which a computer program is stored, where the computer program, upon being executed by a processor, is used for implementing one or more methods described in the embodiments of the present disclosure.

In some embodiments of the present disclosure, the first AP determines the first radio frame, where the first radio frame includes first identification information, and the first identification information identifies whether the first AP supports sharing wireless transmission resource with the second AP, so as to notify the second AP of its capability information of whether it supports sharing wireless transmission resource with the second AP, thereby achieving sharing of wireless transmission resources in the network, and at the same time reducing interference to other devices (e.g., non-shared APs) in the OBSS. So wireless transmission resources in an available state can be reasonably coordinated, thereby improving utilization rate of the wireless transmission resources, and realizing coordination of the wireless transmission resources between multiple APs.

Additional aspects and advantages of the embodiments of the present disclosure will be partially given in the description below, which will become apparent from the description below, or will be learned through practice of the present disclosure.

### BRIEF DESCRIPTION OF THE DRAWINGS

In order to more clearly illustrate the technical solution of the embodiments of the present disclosure, the accompanying drawings required for describing of the embodiments of the present disclosure are briefly introduced as follows. Obviously, the accompanying drawings in the following description are only some embodiments of the present disclosure. For those skilled in the art, other accompanying drawings can be obtained based on these accompanying drawings without creative labor.

FIG. 1 is a first flow chart of a communication method according to an embodiment of the present disclosure.

FIG. 2 is a first schematic diagram of a first example according to an embodiment of the present disclosure.

FIG. 3 is a second schematic diagram of the first example according to an embodiment of the present disclosure.

FIG. 4 is a second flowchart of the communication method according to an embodiment of the present disclosure.

FIG. 5 is a first block diagram of an electronic device according to an embodiment of the present disclosure.

FIG. 6 is a second block diagram of an electronic device according to an embodiment of the present disclosure.

FIG. 7 is a third block diagram of the electronic device according to an embodiment of the present disclosure.

### DETAILED DESCRIPTION

Exemplary embodiments will be described in detail herein, examples of which are shown in the accompanying drawings. Unless otherwise indicated, when the following description refers to the drawings, the same numbers in different drawings represent the same or similar elements. The embodiments described in the following exemplary embodiments do not represent all embodiments consistent with the present invention. Instead, they are merely examples of devices and methods consistent with some aspects of the present invention as detailed in the appended claims.

In the embodiments of the present disclosure, the terms used are only for the purpose of describing specific embodiments and are not intended to limit the present disclosure. The singular forms of “a”, “said” and “the” used in the present disclosure and the appended claims are also intended to include plural forms, unless the context clearly indicates other meanings. It should also be understood that the term “and/or” used in this article refers to and includes any or all possible combinations of one or more associated listed items. For example, A and/or B may represent: A exists alone, both A and B exist, and B exists alone. The character “/” generally indicates that the objects associated before and after are in an “or” relationship. The term “multiple” refers to two or more. In view of this, “multiple” can also be understood as “at least two” in the embodiments of the present disclosure.

It should be understood that although the terms first, second, third, and the like may be used in the present disclosure to describe various information, such information should not be limited to these terms. These terms are only used to distinguish the same type of information from each other. For example, without departing from the scope of the present disclosure, the first information may also be referred to as the second information, and similarly, the second information may also be referred to as the first information. Depending on the context, for example, the word “if” as used herein may be interpreted as “when” or “upon” or “in response to determining . . . ”

The following will be combined with the drawings in the embodiments of the present disclosure to clearly and completely describe the technical solutions according to some embodiments of the present disclosure. Obviously, the described embodiments are only part of the embodiments of the present disclosure, not all of the embodiments. Based on the embodiments in the present disclosure, all other embodiments obtained by those skilled in the art without making creative work shall fall within the protection scope of the present disclosure.

The embodiments of the present disclosure provide a communication method, an electronic device, and a storage medium, which are used to provide a specific manner for coordinating resources among multiple APs.

Herein, the methods and the devices are based on the same application concept. Since the methods and the devices solve the problem in a similar principle, the embodiments of the devices and the methods can refer to each other, and the repeated parts will not be elaborated.

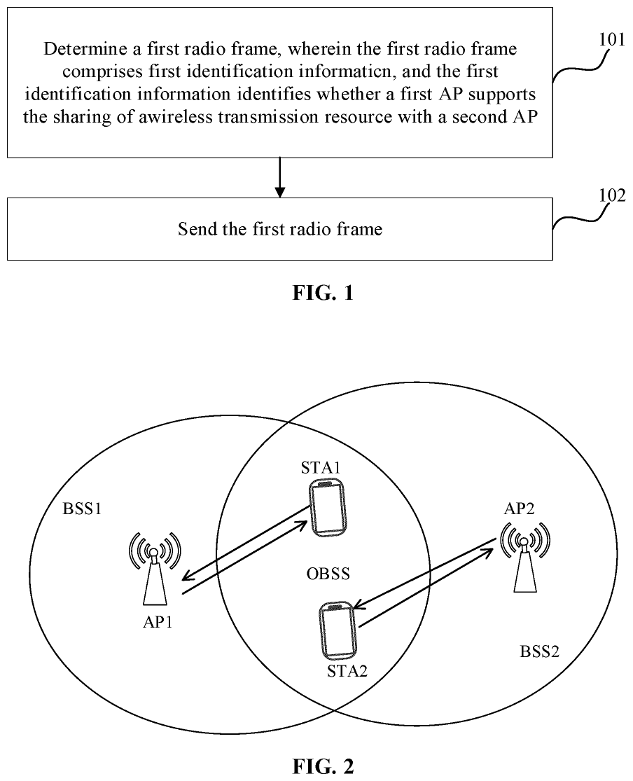

As shown in FIG. 1, an embodiment of the present disclosure provides a communication method, which may be optionally applied to a first access point (AP) device. Optionally, in an embodiment of the present disclosure, the AP is, for example, a device having a wireless to wired bridging function, and the AP is responsible for extending the services provided by a wired network to a wireless network; a station device (STA) is, for example, an electronic device having a wireless network access function, and provides a frame delivery service to enable information to be transmitted.

The method may include the following step(s).

In step 101, a first radio frame is determined, where the first radio frame includes first identification information, and the first identification information identifies whether the first AP supports sharing wireless transmission resource(s) with the second AP.

In a wireless LAN, a Basic Service Set (BSS) may be composed of an AP and one or more stations (STAs) communicating with the AP. A BSS may be connected to a Distribution System (DS) through its AP, and then connected to another BSS to form an Extended Service Set (ESS). As a first example, see FIG. 2, AP1 and STAI form BSS1, and AP2 and STA2 form BSS2; when the coverages of two or more BSSs overlap with each other, an Overlapping Basic Service Set (OBSS) is formed. As shown in FIG. 2, BSS1 and BSS2 overlap to form OBSS.

Optionally, in the disclosed embodiments, AP and STA may be devices supporting multiple links, for example, may be represented as AP MLD (Multi-Link Device) and non-AP MLD, respectively. AP MLD may represent an access point supporting multi-link communication function, and non-AP MLD may represent a station supporting multi-link communication function.

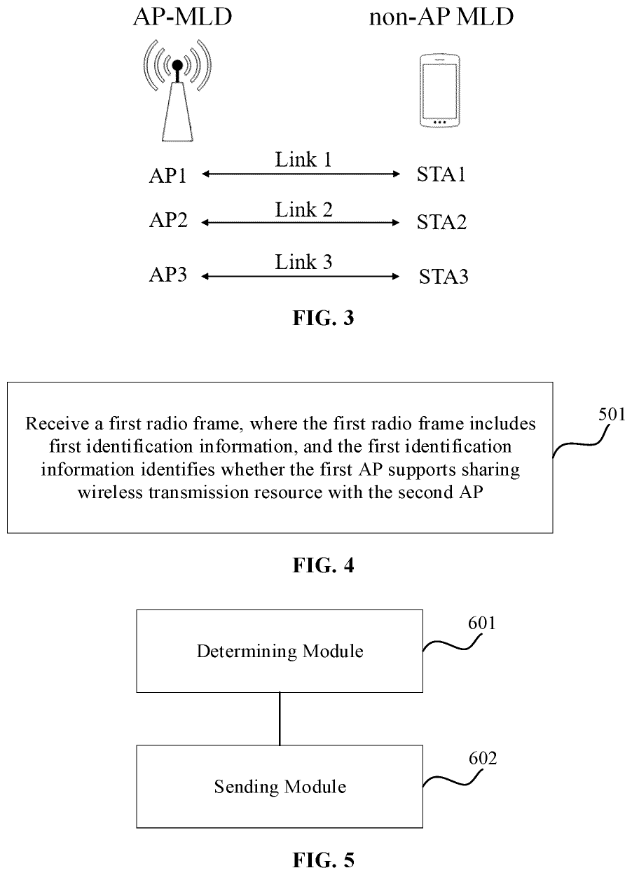

Referring to FIG. 3, AP MLD may include three subordinate APs, such as AP1, AP2 and AP3 as shown in FIG. 3; each AP may work in Link 1, Link 2 and Link 3 respectively. Non-AP MLD may also include three subordinate STAs, such as STA1, STA2 and STA3 as shown in FIG. 3; STA1 works in Link 1, STA2 works in Link 2 and STA3 works in Link 3.

For ease of description, the following mainly describes an example of an AP communicating with an STA under multiple links, however, the exemplary embodiments of the present disclosure are not limited thereto. In the example of FIG. 3, it is assumed that AP1 communicates with STA1 through a corresponding first link “Link 1”, similarly, AP2 communicates with STA2 through a corresponding second link “Link 2”, and AP communicates with STA3 through a third link “Link 3”. In addition, Link 1 to Link 3 may be multiple links at different frequencies, for example, links at 2.4 GHz, 5 GHz, and 6 GHz; or several links of the same or different bandwidths at 2.4 GHz. In addition, multiple channels may exist under each link. It is to be understood that the communication scenario shown in FIG. 3 is merely exemplary, and the present disclosure is not limited thereto. For example, an AP MLD may be connected to multiple (for example, three) non-AP MLDs, or under each link, an AP may communicate with multiple other types of stations.

In UHR, wireless transmission resources may be coordinated between multiple APs to enhance the management of OBSS. Optionally, an AP that shares resources with other APs may be called a sharing AP, such as the first AP according to some embodiments of the present disclosure; an AP that receives resources shared by other APs may be called a shared AP, such as the second AP according to some embodiments of the present disclosure. The first AP determines a first radio frame, carries first identification information in the first radio frame, and identifies whether the first AP supports sharing wireless transmission resources with the second AP through the first identification information. The wireless transmission resources may include bandwidth (BW), spatial streams (SS), and the like.

Optionally, the first radio frame includes a beacon frame or a probe response frame.

Optionally, the first identification information may occupy one bit. For example, when the first identification information is set to “1”, it indicates that the first AP supports sharing wireless transmission resources with other second APs; when the first identification information is set to “0”, it indicates that the first AP does not support sharing wireless transmission resources with other second APs.

In step 102, the first radio frame is sent.

Optionally, the first AP may periodically send the first radio frame at a certain time interval to notify the second AP of its ability to share wireless transmission resources with the second AP, thereby achieving sharing of wireless transmission resources in the network, and at the same time reducing interference to other devices (e.g., non-shared APs) in the OBSS. So wireless transmission resources in an available state can be reasonably coordinated, thereby improving utilization rate of the wireless transmission resources, and realizing coordination of the wireless transmission resources between multiple APs.

For example, taking the first radio frame including the beacon frame as an example, the first AP sends the beacon frame, where the beacon frame may include a common time interval. The second AP that receives the beacon frame in this time interval can determine whether the first AP supports sharing wireless transmission resources based on the first identification information; if yes, when the second AP is to use the wireless transmission resources shared by the first AP, it can use the wireless transmission resources to improve service transmission efficiency.

The embodiments of the present disclosure provide a communication method. Optionally, the method may be applied to the first AP and include the following step(s):
determining a first radio frame, where the first radio frame includes first identification information, and the first identification information identifies whether the first AP supports sharing wireless transmission resource(s) with a second AP;
where the first radio frame further includes second identification information, and the second identification information identifies the first AP as a sharing device or a shared device; and
sending the first radio frame.

The first radio frame also includes second identification information, which identifies the first AP as a sharing device (sharing AP) or a shared device (shared AP). Another bit may be used to identify it as a sharing AP or a shared AP, for example, “0” may be used to identify it as a shared AP, and “1” may be used as a sharing AP.

The embodiments of the present disclosure provide a communication method. Optionally, the method may be applied to the first AP and include the following step(s):
determining a first radio frame, where the first radio frame includes first identification information, and the first identification information identifies whether the first AP supports sharing wireless transmission resource(s) with a second AP;
where the first radio frame further includes at least two pieces of second identification information, and the second identification information identifies the first AP as a sharing device or a shared device; and
sending the first radio frame.

Each piece of second identification information corresponds to a resource sharing group to which the first AP belongs; each resource sharing group includes the first AP and at least one second AP. In other words, each resource sharing group may include a sharing device and a shared device, or a sharing device and at least two shared devices.

In some embodiments, the first AP may serve as both a sharing AP and a shared AP, for example, when the first AP belongs to different resource sharing groups. Accordingly, the first radio frame may include at least two pieces of the second identification information, and the corresponding relationship between the resource sharing groups and the second identification information may be associated in the first radio frame. For example, ID (identity) of the resource sharing group to which it belongs is added in the second identification information.

The embodiments of the present disclosure provide a communication method. Optionally, the method may be applied to the first AP and include the following step(s):
determining a first radio frame, where the first radio frame includes first identification information, and the first identification information identifies whether the first AP supports sharing wireless transmission resource(s) with a second AP;
sending the first radio frame; and
sending a trigger frame, where the trigger frame carries third identification information, and the third identification information includes device identification information of the second AP and/or resource identification information of the wireless transmission resource shared by the first AP.

The first AP may send the trigger frame (trigger) at a certain bandwidth, for example, at a bandwidth of 80 MHz or 160 MHz. The trigger frame carries third identification information, and the third identification information includes: the device identification information of the second AP, and/or the resource identification information of the wireless transmission resource shared by the first AP. In other words, the third identification information includes at least one of the device identification information of the shared AP and the resource identification information.

The embodiments of the present disclosure provide a communication method. Optionally, the method may be applied to the first AP and include the following step(s):
determining a first radio frame, where the first radio frame includes first identification information, and the first identification information identifies whether the first AP supports sharing wireless transmission resource(s) with a second AP;
sending the first radio frame; and
sending a trigger frame, where the trigger frame carries third identification information, and the third identification information includes device identification information of the second AP and/or resource identification information of the wireless transmission resource shared by the first AP.

The device identification information includes at least one of the following:
BSSID information, media access control (MAC) address information of the second AP, and an identifier assigned by the first AP to the second AP; where the identifier may be an association identifier (AID) or a MAC address.

The embodiments of the present disclosure provide a communication method. Optionally, the method may be applied to the first AP and include the following step(s):
determining a first radio frame, where the first radio frame includes first identification information, and the first identification information identifies whether the first AP supports sharing wireless transmission resource(s) with a second AP;
sending the first radio frame; and
sending a trigger frame, where the trigger frame carries third identification information, and the third identification information includes device identification information of the second AP and/or resource identification information of the wireless transmission resource shared by the first AP.

In some embodiments, the resource identification information is set to a first parameter value, indicating that the corresponding wireless transmission resource is wireless transmission resource shared by the first AP to the second AP. For example, when the first parameter value is “1”, it indicates that the resource corresponding to the resource identification information is the wireless transmission resource shared by the first AP to the second AP.

For example, the shared AP identifies corresponding wireless transmission resources, with a unit of wireless transmission resource being a multiple of 20 MHz. One piece of resource identification information is set for each unit of wireless transmission resource, with each piece of resource identification information occupying one bit, so the total resource identification information may be 16 bits or more.

The embodiments of the present disclosure provide a communication method. Optionally, the method may be applied to the first AP and include the following step(s):
determining a first radio frame, where the first radio frame includes first identification information, and the first identification information identifies whether the first AP supports sharing wireless transmission resource(s) with a second AP;
sending the first radio frame; and
sending a trigger frame, where the trigger frame carries third identification information, the third identification information includes device identification information of the second AP and/or resource identification information of the wireless transmission resource shared by the first AP; and the third identification information is carried in a site information field (STA info) of the trigger frame, that is, in the STA info field.

In an optional embodiment, a common information field of the trigger frame includes at least one of the following:
bandwidth parameter information, transmission opportunity TXOP information of the first AP, and group identification information of a resource sharing group to which the first AP and the second AP belong.

Here, the common information field includes at least one of the bandwidth parameter information, the TXOP information, and the group identification information of the resource sharing group. Specifically, the bandwidth parameter information includes: a sum of a communication bandwidth occupied by the first AP and a communication bandwidth shared by the first AP to the second AP. In other words, the bandwidth parameter information includes the sum of the bandwidth occupied by the first AP itself and the bandwidth shared to the second AP. For example, the first AP allocates 100 MHz bandwidth to the second AP, and the first AP itself uses 60 MHz bandwidth for communication, then the bandwidth parameter information is 160 MHz.

The transmit opportunity (TXOP) information includes at least two of the following:
a start time, an end time, and a duration of the TXOP, thereby facilitating the second AP to determine the specific duration of the TXOP.

The group identification information of the resource sharing group is used by the second AP in the group to identify information on wireless transmission resource shared by the first AP to the second AP.

The embodiments of the present disclosure provide a communication method. Optionally, the method may be applied to the first AP and include the following step(s):
determining a first radio frame, where the first radio frame includes first identification information, and the first identification information identifies whether the first AP supports sharing wireless transmission resource(s) with a second AP;
sending the first radio frame.

Optionally, the first radio frame further includes second identification information; and
the second identification information identifies the first AP as a sharing device or a shared device.

Optionally, the first radio frame includes at least two pieces of the second identification information;
each piece of the second identification information corresponds to a resource sharing group to which the first AP belongs; and
each resource sharing group includes the first AP and at least one second AP.

Optionally, after sending the first radio frame, the method includes:
sending a trigger frame, where the trigger frame carries third identification information, and the third identification information includes device identification information of the second AP and/or resource identification information of the wireless transmission resource shared by the first AP.

Optionally, the device identification information includes at least one of the following:
BSSID information, MAC address information of the second AP, and an identifier assigned by the first AP to the second AP.

Optionally, the resource identification information is set to a first parameter value, indicating that the corresponding wireless transmission resource is a wireless transmission resource shared by the first AP to the second AP.

Optionally, the third identification information is carried in a site information field (STA info) of the trigger frame.

Optionally, a common information field of the trigger frame includes at least one of the following:
bandwidth parameter information, transmission opportunity TXOP information of the first AP, and group identification information of a resource sharing group to which the first AP and the second AP belong.

Optionally, the bandwidth parameter information includes: a sum of a communication bandwidth occupied by the first AP and a communication bandwidth shared by the first AP to the second AP.

Optionally, the TXOP information includes at least two of the following:
a start time, an end time, and a duration of the TXOP.

Optionally, the first radio frame includes a beacon frame or a probe response frame.

In some embodiments of the present disclosure, the first AP determines the first radio frame, where the first radio frame includes first identification information, and the first identification information identifies whether the first AP supports sharing wireless transmission resource with the second AP, so as to notify the second AP of its capability information of whether it supports sharing wireless transmission resource with the second AP, thereby achieving sharing of wireless transmission resources in the network, and at the same time reducing interference to other devices (e.g., non-shared APs) in the OBSS. So wireless transmission resources in an available state can be reasonably coordinated, thereby improving utilization rate of the wireless transmission resources, and realizing coordination of the wireless transmission resources between multiple APs.

Referring to FIG. 4, embodiments of the present disclosure provide a communication method. Optionally, the method may be applied to a second access point device AP and include the following step(s).

In step 501, a first radio frame is received, where the first radio frame includes first identification information, and the first identification information identifies whether the first AP supports sharing wireless transmission resource(s) with the second AP.

Herein, as to the WLAN architecture applied to the communication method according to such embodiments of the present disclosure, the aforementioned first example may be referred to and will not be repeated here.

In UHR, wireless transmission resources may be coordinated between multiple APs to enhance the management of OBSS. Optionally, an AP that shares resources with other APs may be called a sharing AP, such as the first AP according to some embodiments of the present disclosure; an AP that receives resources shared by other APs may be called a shared AP, such as the second AP according to some embodiments of the present disclosure. The second AP receives a first radio frame, obtains first identification information carried in the first radio frame, and determines whether the first AP supports sharing wireless transmission resources with the second AP through the first identification information. The wireless transmission resources may include bandwidth (BW), spatial streams (SS), and the like.

Optionally, the first radio frame includes a beacon frame or a probe response frame.

Optionally, the first identification information may occupy one bit. For example, when the first identification information is set to “1”, it indicates that the first AP supports sharing wireless transmission resources with other second APs; when the first identification information is set to “0”, it indicates that the first AP does not support sharing wireless transmission resources with other second APs.

The second AP receives the first radio frame, obtains the first identification information carried in the first radio frame, and determines whether the first AP supports sharing wireless transmission resources with the second AP through the first identification information, thereby achieving sharing of wireless transmission resources in the network, and at the same time reducing interference to other devices (e.g., non-shared APs) in the OBSS. So wireless transmission resources in an available state can be reasonably coordinated, thereby improving utilization rate of the wireless transmission resources, and realizing coordination of the wireless transmission resources between multiple APs.

The embodiments of the present disclosure provide a communication method. Optionally, the method may be applied the second AP and include the following step(s):
receiving a first radio frame, where the first radio frame includes first identification information, and the first identification information identifies whether the first AP supports sharing wireless transmission resource(s) with a second AP;
the first radio frame further includes second identification information; and
the second identification information identifies the first AP as a sharing device or a shared device.

The first radio frame also includes second identification information, which identifies the first AP as a sharing device (sharing AP) or a shared device (shared AP). Another bit may be used to identify it as a sharing AP or a shared AP, for example, “0” may be used to identify it as a shared AP, and “1” may be used as a sharing AP.

The embodiments of the present disclosure provide a communication method. Optionally, the method may be applied the second AP and include the following step(s):
receiving a first radio frame, where the first radio frame includes first identification information, and the first identification information identifies whether the first AP supports sharing wireless transmission resource(s) with a second AP;
the first radio frame further includes at least two pieces of second identification information;
each piece of second identification information corresponds to a resource sharing group to which the first AP belongs;
each resource sharing group includes the first AP and at least one second AP; and
the second identification information identifies the first AP as a sharing device or a shared device.

In some embodiments, the first AP may serve as both a sharing AP and a shared AP, for example, when the first AP belongs to different resource sharing groups. Accordingly, the first radio frame may include at least two pieces of the second identification information, and the corresponding relationship between the resource sharing groups and the second identification information may be associated in the first radio frame. For example, ID (identity) of the resource sharing group to which it belongs is added in the second identification information.

The embodiments of the present disclosure provide a communication method. Optionally, the method may be applied the second AP and include the following step(s):
receiving a first radio frame, where the first radio frame includes first identification information, and the first identification information identifies whether the first AP supports sharing wireless transmission resource(s) with a second AP; and
receiving a trigger frame, where the trigger frame carries third identification information, and the third identification information includes device identification information of the second AP and/or resource identification information of the wireless transmission resource shared by the first AP.

Here, the second AP may receive the trigger frame (trigger) at a certain bandwidth, for example, at a bandwidth of 80 MHz or 160 MHz; obtain the third identification information carried in the trigger frame, where the third identification information includes: the device identification information of the second AP, and/or the resource identification information of the wireless transmission resource shared by the first AP. In other words, the third identification information includes at least one of the device identification information of the shared AP and the resource identification information.

The embodiments of the present disclosure provide a communication method. Optionally, the method may be applied the second AP and include the following step(s):
receiving a first radio frame, where the first radio frame includes first identification information, and the first identification information identifies whether the first AP supports sharing wireless transmission resource(s) with a second AP; and
receiving a trigger frame, where the trigger frame carries third identification information, and the third identification information includes device identification information of the second AP and/or resource identification information of the wireless transmission resource shared by the first AP.

The device identification information includes at least one of the following:
BSSID information, media access control (MAC) address information of the second AP, and an identifier assigned by the first AP to the second AP; where the identifier may be an association identifier (AID) or a MAC address.

The embodiments of the present disclosure provide a communication method. Optionally, the method may be applied the second AP and include the following step(s):
receiving a first radio frame, where the first radio frame includes first identification information, and the first identification information identifies whether the first AP supports sharing wireless transmission resource(s) with a second AP; and
receiving a trigger frame, where the trigger frame carries third identification information, and the third identification information includes device identification information of the second AP and/or resource identification information of the wireless transmission resource shared by the first AP. The resource identification information is set to a first parameter value, indicating that the corresponding wireless transmission resource is wireless transmission resource shared by the first AP to the second AP. For example, when the first parameter value is “1”, it indicates that the resource corresponding to the resource identification information is the wireless transmission resource shared by the first AP to the second AP.

For example, the shared AP identifies corresponding wireless transmission resources, with a unit of wireless transmission resource being a multiple of 20 MHz. One piece of resource identification information is set for each unit of wireless transmission resource, with each piece of resource identification information occupying one bit, so the total resource identification information may be 16 bits or more.

The embodiments of the present disclosure provide a communication method. Optionally, the method may be applied the second AP and include the following step(s):
receiving a first radio frame, where the first radio frame includes first identification information, and the first identification information identifies whether the first AP supports sharing wireless transmission resource(s) with a second AP; and
receiving a trigger frame, where the trigger frame carries third identification information, and the third identification information includes device identification information of the second AP and/or resource identification information of the wireless transmission resource shared by the first AP. The third identification information is carried in the site information field STA info of the trigger frame, i.e., the STA info field.

In an optional embodiment, a common information field (common info) of the trigger frame includes at least one of the following:
bandwidth parameter information, transmission opportunity TXOP information of the first AP, and group identification information of a resource sharing group to which the first AP and the second AP belong.

Here, the common information field includes at least one of the bandwidth parameter information, the TXOP information, and the group identification information of the resource sharing group. Specifically, the bandwidth parameter information includes: a sum of a communication bandwidth occupied by the first AP and a communication bandwidth shared by the first AP to the second AP. In other words, the bandwidth parameter information includes the sum of the bandwidth occupied by the first AP itself and the bandwidth shared to the second AP. For example, the first AP allocates 100 MHz bandwidth to the second AP, and the first AP itself uses 60 MHz bandwidth for communication, then the bandwidth parameter information is 160 MHz.

The transmit opportunity (TXOP) information includes at least two of the following:
a start time, an end time, and a duration of the TXOP; that is, including at least two of the start time of TXOP, the end time of TXOP and the duration of TXOP, thereby facilitating the second AP to determine the specific duration of the TXOP.

The group identification information of the resource sharing group is used by the second AP in the group to identify information on wireless transmission resource shared by the first AP to the second AP.

The embodiments of the present disclosure provide a communication method. Optionally, the method may be applied the second AP and include the following step(s):
receiving a first radio frame, where the first radio frame includes first identification information, and the first identification information identifies whether the first AP supports sharing wireless transmission resource(s) with a second AP.

Optionally, the first radio frame further includes second identification information; and
the second identification information identifies the first AP as a sharing device or a shared device.

Optionally, the first radio frame includes at least two pieces of the second identification information;
each piece of the second identification information corresponds to a resource sharing group to which the first AP belongs; and
each resource sharing group includes the first AP and at least one second AP.

Optionally, after receiving the first radio frame, the method includes:
receiving a trigger frame, where the trigger frame carries third identification information, and the third identification information includes device identification information of the second AP and/or resource identification information of the wireless transmission resource shared by the first AP.

Optionally, the device identification information includes at least one of the following:
BSSID information, MAC address information of the second AP, and an identifier assigned by the first AP to the second AP.

Optionally, the resource identification information is set to a first parameter value, indicating that the corresponding wireless transmission resource is a wireless transmission resource shared by the first AP to the second AP.

Optionally, the third identification information is carried in a site information field (STA info) of the trigger frame.

Optionally, a common information field of the trigger frame includes at least one of the following:
bandwidth parameter information, transmission opportunity TXOP information of the first AP, and group identification information of a resource sharing group to which the first AP and the second AP belong.

Optionally, the bandwidth parameter information includes: a sum of a communication bandwidth occupied by the first AP and a communication bandwidth shared by the first AP to the second AP.

Optionally, the TXOP information includes at least two of the following:
a start time, an end time, and a duration of the TXOP.

In some embodiments of the present disclosure, the second AP receives the first radio frame, obtains the first identification information carried in the first radio frame, and determines whether the first AP supports sharing wireless transmission resources with the second AP through the first identification information, thereby achieving sharing of wireless transmission resources in the network, and at the same time reducing interference to other devices (e.g., non-shared APs) in the OBSS. So wireless transmission resources in an available state can be reasonably coordinated, thereby improving utilization rate of the wireless transmission resources, and realizing coordination of the wireless transmission resources between multiple APs.

Referring to FIG. 5, based on the same principle as the methods according to the embodiments of the present disclosure, embodiments of the present disclosure further provide an electronic device, where the electronic device is a first AP and includes:
a determining module 601, configured to determine a first radio frame; where the first radio frame includes first identification information, and the first identification information identifies whether the first AP supports sharing wireless transmission resource with a second AP; and
a sending module 602, configured to send the first radio frame.

Optionally, the first radio frame further includes second identification information; and
the second identification information identifies the first AP as a sharing device or a shared device.

Optionally, the first radio frame includes at least two pieces of the second identification information;
each piece of the second identification information corresponds to a resource sharing group to which the first AP belongs; and
each resource sharing group includes the first AP and at least one second AP.

Optionally, the sending module 602 is configured to:
send a trigger frame, where the trigger frame carries third identification information, and the third identification information includes device identification information of the second AP and/or resource identification information of the wireless transmission resource shared by the first AP.

Optionally, the device identification information includes at least one of the following:
BSSID information, MAC address information of the second AP, and an identifier assigned by the first AP to the second AP.

Optionally, the resource identification information is set to a first parameter value, indicating that the corresponding wireless transmission resource is a wireless transmission resource shared by the first AP to the second AP.

Optionally, the third identification information is carried in a site information field (STA info) of the trigger frame.

Optionally, a common information field of the trigger frame includes at least one of the following:
bandwidth parameter information, transmission opportunity TXOP information of the first AP, and group identification information of a resource sharing group to which the first AP and the second AP belong.

Optionally, the bandwidth parameter information includes: a sum of a communication bandwidth occupied by the first AP and a communication bandwidth shared by the first AP to the second AP.

Optionally, the TXOP information includes at least two of the following:
a start time, an end time, and a duration of the TXOP.

Optionally, the first radio frame includes a beacon frame or a probe response frame.

Embodiments of the present disclosure also provide a communication device, which is applied to the first AP and includes:
a radio frame determining module, configured to determine a first radio frame; where the first radio frame includes first identification information, and the first identification information identifies whether the first AP supports sharing wireless transmission resources with the second AP; and
a radio frame sending module, configured to send the first radio frame.

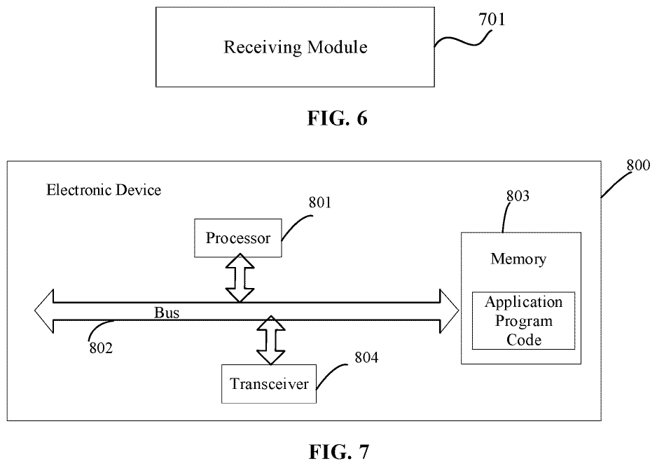

Referring to FIG. 6, based on the same principle as the methods according to the embodiments of the present disclosure, embodiments of the present disclosure further provide an electronic device, where the electronic device is a second AP and includes:
a receiving module 701, configured to receive a first radio frame; where the first radio frame includes first identification information, and the first identification information identifies whether the first AP supports sharing wireless transmission resources with the second AP.

Optionally, the first radio frame further includes second identification information; and
the second identification information identifies the first AP as a sharing device or a shared device.

Optionally, the first radio frame includes at least two pieces of the second identification information;
each piece of the second identification information corresponds to a resource sharing group to which the first AP belongs; and
each resource sharing group includes the first AP and at least one second AP.

Optionally, the receiving module 701 is configured to:
receive a trigger frame, where the trigger frame carries third identification information, and the third identification information includes device identification information of the second AP and/or resource identification information of the wireless transmission resource shared by the first AP.

Optionally, the device identification information includes at least one of the following:
BSSID information, MAC address information of the second AP, and an identifier assigned by the first AP to the second AP.

Optionally, the resource identification information is set to a first parameter value, indicating that the corresponding wireless transmission resource is a wireless transmission resource shared by the first AP to the second AP.

Optionally, the third identification information is carried in a site information field (STA info) of the trigger frame.

Optionally, a common information field of the trigger frame includes at least one of the following:
bandwidth parameter information, transmission opportunity TXOP information of the first AP, and group identification information of a resource sharing group to which the first AP and the second AP belong.

Optionally, the bandwidth parameter information includes: a sum of a communication bandwidth occupied by the first AP and a communication bandwidth shared by the first AP to the second AP.

Optionally, the TXOP information includes at least two of the following:
a start time, an end time, and a duration of the TXOP.

Embodiments of the present disclosure also provide a communication device, which is applied to the second AP and includes:
a radio frame receiving module, configured to receive a first radio frame; where the first radio frame includes first identification information, and the first identification information identifies whether the first AP supports sharing wireless transmission resources with the second AP.

The device may further include other modules of the electronic device in the aforementioned embodiments, which will not be described in detail here.

In an optional embodiment, embodiments of the present disclosure further provide an electronic device, as shown in FIG. 7, the electronic device 800 shown in FIG. 7 may be a server, including: a processor 801 and a memory 803. The processor 801 and the memory 803 are connected, such as through a bus 802. Optionally, the electronic device 800 may further include a transceiver 804. It should be noted that in actual applications, the transceiver 804 is not limited to one, and the structure of the electronic device 800 does not constitute a limitation on the embodiments of the present disclosure.

Processor 801 may be a CPU (Central Processing Unit), a general-purpose processor, a DSP (Digital Signal Processor), an ASIC (Application Specific Integrated Circuit), an FPGA (Field Programmable Gate Array) or other programmable logic devices, transistor logic devices, hardware components or any combination thereof. It can implement or execute various exemplary logic blocks, modules and circuits described in conjunction with the present disclosure. Processor 801 may also be a combination that implements computing functions, such as a combination of one or more microprocessors, DSPs, microprocessors, or the like.

Bus 802 may include a path to transmit information between the above components. Bus 802 may be PCI (Peripheral Component Interconnect) bus, EISA (Extended Industry Standard Architecture) bus, or the like. Bus 802 may be divided into address bus, data bus, control bus, and the like. For ease of representation, only one thick line is used in FIG. 7, but it does not mean that there is only one bus or one type of bus.

Memory 803 may be ROM (Read Only Memory) or other types of static storage devices that can store static information and instructions, RAM (Random Access Memory) or other types of dynamic storage devices that can store information and instructions, EEPROM (Electrically Erasable Programmable Read Only Memory), CD-ROM (Compact Disc Read Only Memory) or other optical disk storage, optical disk storage (including compressed optical disk, laser disk, optical disk, digital versatile disk, Blu-ray disk, and the like), magnetic disk storage medium or other magnetic storage device, or any other medium that can be used to carry or store the desired program code in the form of instructions or data structures and can be accessed by a computer, but is not limited thereto.

Memory 803 is configured to store application code for executing the solution of the present disclosure, and the execution is controlled by the processor 801. The processor 801 is configured to execute the application code stored in the memory 803 to implement the content shown in the above method embodiments.

The electronic device includes, but is not limited to, mobile phones, laptop computers, digital broadcast receivers, PDAs (personal digital assistants), PADs (tablet computers), PMPs (portable multimedia players), vehicle-mounted terminals (such as vehicle-mounted navigation terminals), or the like, and fixed terminals such as digital TVs, desktop computers, or the like. The electronic device shown in FIG. 7 is only an example and should not bring any limitation to the functions and usage scope of the embodiments of the present disclosure.

The server provided by the present disclosure may be an independent physical server, or a server cluster or distributed system composed of multiple physical servers, or a cloud server that provides basic cloud computing services such as cloud services, cloud databases, cloud computing, cloud functions, cloud storage, network services, cloud communications, middleware services, domain name services, security services, CDN, and big data and artificial intelligence platforms. The terminal may be a smart phone, tablet computer, laptop computer, desktop computer, smart speaker, smart watch, or the like, but is not limited thereto. The terminal and the server may be directly or indirectly connected via wired or wireless communication, which is not limited by the present disclosure.

The present disclosure provides a computer-readable storage medium. The computer program is essentially stored therein, and when it is run on a computer, the computer can execute the corresponding contents in the aforementioned method embodiments.

It should be understood that, although the steps in the flowchart of the accompanying drawings are displayed in sequence as indicated by the arrows, these steps are not necessarily executed in sequence in the order indicated by the arrows. Unless otherwise specified herein, there is no strict order restriction on the execution of these steps, and they can be executed in other orders. Moreover, at least a part of the steps in the flowchart of the accompanying drawings may include multiple sub-steps or multiple stages, and these sub-steps or stages are not necessarily executed at the same time, but can be executed at different times; and their execution order is not necessarily sequential, but can be executed in turn or alternately with other steps or at least a part of the sub-steps or stages of other steps.

It should be noted that the computer-readable medium disclosed above may be a computer-readable signal medium or a computer-readable storage medium or any combination of the above two. The computer-readable storage medium may be, for example, but not limited to, an electrical, magnetic, optical, electromagnetic, infrared, or semiconductor system, apparatus or device, or any combination of the above. More specific examples of computer-readable storage medium may include, but are not limited to: an electrical connection with one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, a computer-readable storage medium may be any tangible medium containing or storing a program that may be used by or in combination with an instruction execution system, apparatus or device. In the present disclosure, a computer-readable signal medium may include a data signal propagated in a baseband or as part of a carrier wave, in which a computer-readable program code is carried. This propagated data signal may take a variety of forms, including but not limited to an electromagnetic signal, an optical signal, or any suitable combination of the above. The computer readable signal medium may also be any computer readable medium other than a computer readable storage medium, which may send, propagate or transmit a program for use by or in conjunction with an instruction execution system, apparatus or device. The program code contained on the computer readable medium may be transmitted using any suitable medium, including but not limited to: wires, optical cables, RF (radio frequency), or the like, or any suitable combination of the above.

The computer readable medium may be included in the electronic device; or it may be present separately without being not incorporated into the electronic device.

The computer-readable medium carries one or more programs. When the one or more programs are executed by the electronic device, the electronic device executes the method shown in the above embodiments.

According to one aspect of the present disclosure, a computer program product or a computer program is provided, where the computer program product or the computer program includes computer instructions, and the computer instructions are stored in a computer-readable storage medium. A processor of a computer device reads the computer instructions from the computer-readable storage medium, and the processor executes the computer instructions, thereby causing the computer device to implement the methods according to the various optional implementations as mentioned above.

Computer program code for performing the operations of the present disclosure may be written in one or more programming languages, or a combination thereof, including object-oriented programming languages, such as Java, Smalltalk, C++, and conventional procedural programming languages, such as “C” or similar programming languages. The program code may be executed entirely on the user's computer; or partially on the user's computer; or as a separate software package; or partially on the user's computer and partially on a remote computer; or entirely on a remote computer or server. In cases involving a remote computer, the remote computer may be connected to the user's computer through any type of network, including a local area network (LAN) or a wide area network (WAN), or may be connected to an external computer (e.g., through the Internet using an Internet service provider).

The flow chart and block diagram in the accompanying drawings illustrate the possible architecture, function and operation of the system, method and computer program product according to various embodiments of the present disclosure. In this regard, each square box in the flow chart or block diagram can represent a module, a program segment or a partial code, and the module, the program segment or the partial code contains one or more executable instructions for realizing the specified logical function. It should also be noted that in some implementations as replacements, the functions marked in the square box may also occur in a sequence different from that marked in the accompanying drawings. For example, two square boxes represented in succession can actually be executed substantially in parallel, and they can sometimes be executed in the opposite order, depending on the functions involved. It should also be noted that each square box in the block diagram and/or flow chart, and the combination of the square boxes in the block diagram and/or flow chart can be implemented with a dedicated hardware-based system that performs a specified function or operation, or can be implemented with a combination of dedicated hardware and computer instructions.

The modules involved in the embodiments of the present disclosure can be implemented by software. It can be implemented by hardware. The name of a module does not limit the module itself in some cases. For example, module A can also be described as “module A configured to perform operation B”.

The above description includes only some preferred embodiments of the present disclosure and an explanation of the technical principles used. Those skilled in the art should understand that the scope of disclosure involved in the present disclosure is not limited to the technical solutions formed by a specific combination of the above technical features, but should also cover other technical solutions formed by any combination of the above technical features or their equivalent features without departing from the above disclosed concept. For example, the above features are replaced with the technical features with similar functions disclosed in the present disclosure (but not limited to) by each other.

1. A communication method, comprising:
determining, by a first access point (AP), a first radio frame; wherein the first radio frame comprises first identification information, and the first identification information identifies whether the first AP supports sharing wireless transmission resource with a second AP; and
sending the first radio frame.

2. The communication method according to claim 1, wherein the first radio frame further comprises second identification information; and
the second identification information identifies the first AP as a sharing device or a shared device.

3. The communication method according to claim 2, wherein the first radio frame comprises at least two pieces of the second identification information;
each piece of the second identification information corresponds to a resource sharing group to which the first AP belongs; and
each resource sharing group comprises the first AP and at least one second AP.

4. The communication method according to claim 1, further comprising:
sending a trigger frame, wherein the trigger frame carries third identification information, and the third identification information comprises device identification information of the second AP or resource identification information of the wireless transmission resource shared by the first AP.

5. The communication method according to claim 4, wherein the device identification information comprises at least one of following:
basic service set identity (BSSID) BSSID-information, media access control (MAC) address information of the second AP, and an identifier allocated by the first AP to the second AP.

6. The communication method according to claim 4, wherein the resource identification information is set to a first parameter value, indicating that the corresponding wireless transmission resource is wireless transmission resource shared by the first AP to the second AP.

7. The communication method according to claim 4, wherein the third identification information is carried in a site information field (STA info) of the trigger frame.

8. The communication method according to claim 4, wherein a common information field of the trigger frame comprises at least one of following:
bandwidth parameter information, transmission opportunity (TXOP) information of the first AP, and group identification information of a resource sharing group to which the first AP and the second AP belong.

9. The communication method according to claim 8, wherein the bandwidth parameter information comprises: a sum of a communication bandwidth occupied by the first AP and a communication bandwidth shared by the first AP to the second AP.

10. The communication method according to claim 8, wherein the TXOP information comprises at least two of following:
a start time, an end time, and a duration of the TXOP.

11. The communication method according to claim 1, wherein the first radio frame comprises a beacon frame or a probe response frame.

12. A communication method, comprising:
receiving, by a second access point (AP), a first radio frame; wherein the first radio frame comprises first identification information, and the first identification information identifies whether a first AP supports sharing wireless transmission resource with the second AP.

13. The communication method according to claim 12, wherein the first radio frame further comprises second identification information; and
the second identification information identifies the first AP as a sharing device or a shared device.

14. The communication method according to claim 13, wherein the first radio frame comprises at least two pieces of the second identification information;
each piece of the second identification information corresponds to a resource sharing group to which the first AP belongs; and
each resource sharing group comprises the first AP and at least one second AP.

15. The communication method according to claim 12, further comprising:
receiving a trigger frame, wherein the trigger frame carries third identification information, and the third identification information comprises device identification information of the second AP or resource identification information of the wireless transmission resource shared by the first AP.

16. The communication method according to claim 15, wherein the device identification information comprises at least one of following:
basic service set identity (BSSID) information, media access control (MAC) address information of the second AP, and an identifier allocated by the first AP to the second AP.

17. The communication method according to claim 15, wherein the resource identification information is set to a first parameter value, indicating that the corresponding wireless transmission resource is wireless transmission resource shared by the first AP to the second AP.

18. The communication method according to claim 15, wherein the third identification information is carried in a site information field (STA info) of the trigger frame.

19-26. (canceled)

27. A first access point (AP) device, comprising:
a processor; and
a memory storing instructions executable by the processor,
wherein the processor is configured to:
determine a first radio frame; wherein the first radio frame comprises first identification information, and the first identification information identifies whether the first AP supports sharing wireless transmission resource with a second AP; and
send the first radio frame.

28. A second access point (AP) device, comprising:
a processor; and
a memory storing instructions executable by the processor,
wherein the processor is configured to execute the method according to claim 12.
